(19) United States
(12) Patent Application Publication
(10) Pub. No.: US 2014/0306509 A1
(43) Pub. Date: Oct. 16, 2014

(54) Auxiliary wheel apparatus for vehicles

(71) Applicant: Ravi Ganesh Athalye, Pune (IN)

(72) Inventor: Ravi Ganesh Athalye, Pune (IN)

(21) Appl. No.: 13/986,225

(22) Filed: Apr. 15, 2013

(51) Int. Cl. B60B 11/10

(52) U.S. Cl. CPC B60B 11/10
USPC 301/9.1

(57) ABSTRACT

The present invention discloses an auxiliary wheel apparatus for a vehicle that comprises an auxiliary wheel that facilitates connection of a plurality of user configured means thereto. The user configured means gives an early indication of an under inflated or deflated state of the vehicle wheel to a remote observer. The auxiliary wheel contacts and rotates on a ground by facilitating support in the under inflated or deflated state of the vehicle wheel. The auxiliary wheel facilitates the vehicle to be driven at a reduced speed without limitation in the under inflated or deflated state of vehicle wheel.

### FIELD OF THE INVENTION

The invention relates to safety wheels for vehicles and more particularly to an auxiliary safety wheel adapted to be externally mounted on a vehicle wheel.

### BACKGROUND OF THE INVENTION

Auxiliary safety wheels are well known in the art for their function of reducing dangers arising due to punctures of blow-outs of the vehicle tyres. These auxiliary safety wheels are normally permanently connected to the rims of the wheels and generally have a diameter that is greater than the diameter of rim and less than the diameter of the tire. For example, U.S. Pat. No. 2,670,994 to Parrorr et al. teaches one such auxiliary safety wheel that is used in conjunction with wheels on which the pneumatic tyres are mounted. Further, U.S. Pat. No. 3,397,014 to Nigrelli et al. describes an auxiliary or safety wheel which is associated with a main wheel having a pneumatic tire. The auxiliary wheel is permanently secured to the main wheel, and in one embodiment is, in part, integrally formed with the main wheel. However, in case of failure of these auxiliary wheels, entire vehicle wheel needs be removed from its position for replacement as it is permanently connected to the auxiliary wheel.

Use of removable and replaceable auxiliary safety wheels is also seen in the art in to replace permanently connectable auxiliary safety wheels. For example, U.S. Pat. No. 4,158,468 to Bass et al. discloses a safety wheel for trucks or other motor vehicles, including a safety flange which is detachably connectable to the tire mounting rim of a wheel body. Also, U.S. Pat. No. 3,942,571 to Kraft teaches a tire safety support for mounting on a wheel rim to support a pneumatic tire in a deflated condition including a ring member mounted on the wheel rim inside the tire. Further, U.S. Pat. No. 2,354,444 to Lyon refers to a wheel that includes projected restrictor rings removably attached to the flanges of a conventional tyre rim whereby the lateral bulge of the sides of a tire when the tire is in service is restricted to a predetermined limit and whereby auxiliary road contact members are provided. However, these removable auxiliary safety wheels are found to be incompetent to work on the soft ground such as a soggy or muddy terrain as they lack means to facilitate propulsion of the vehicle.

There are few attempts seen in the art to provide propelling means on the auxiliary wheels. For example, U.S. Pat. No. 4,906,051 to Jacob relates to an auxiliary traction device for vehicle wheels to enhance their traction and braking characteristics under ice and snow conditions. Also, U.S. Pat. No. 4,854,357 to Maher A. H. Mostaga Taha teaches an apparatus for use with an automotive wheel including a tire to provide additional traction that includes a first and a second ring member fabricated of hard grooved metal material held in a spaced-apart parallel relation by a plurality of transversely oriented angled bar members that are rigidly connected at each end and equally spaced along the circumference of the rings. Further, U.S. Pat. No. 4,383,665 to Maclean and Spector describes a device for rotating a wheel of an aircraft prior to landing comprising a wheel member having a rim with a tire and a hub projecting from one side of said wheel member in combination with spaced curved arms extending radially from said hub. The wheel member includes a plurality of flexible fins supported pivotally free on pivot pins and are eccentrically mounted on each of said arms. However, these propelling means in combination with the auxiliary wheels cover large area over the tyres thereby making the observer to put tiresome efforts in checking deflated state of the tyres.

Accordingly, there exists a need of an auxiliary wheel that gives a remote indication of the deflated state of tyres of the vehicle wheel in addition to facilitating supporting and traction means for the vehicle wheel.

### OBJECTS OF THE INVENTION

An object of the present invention is to provide an auxiliary wheel that externally supports a vehicle wheel in case of deflation of.

Another object of the present invention is to provide a traction means on an auxiliary wheel that empowers a vehicle in situations where the wheel sinks in soft ground.

Further object of the present invention is to provide an indication mechanism that gives an indication of deflation of the vehicle wheel.

### SUMMARY OF THE INVENTION

The present invention provides an auxiliary wheel apparatus for a vehicle that comprises an auxiliary wheel having a front end and a rear end. The front end includes a plurality of holes that facilitates connection of a plurality of user configured means thereto. The user configured means gives an early indication of an under inflated or deflated state of the vehicle wheel to a remote observer. The auxiliary wheel apparatus includes a cylindrical projection having a first end and a second end. The first end permanently connects to the rear end of the auxiliary wheel. The second end has a plurality of holes that connects to a plurality of screws defined on an axle of the vehicle wheel for facilitating engagement between the auxiliary wheel and the vehicle wheel. The cylindrical projection keeps the auxiliary wheel at a predefined distance from the vehicle wheel. The auxiliary wheel contacts and rotates on a ground by facilitating support in the under inflated or deflated state of the vehicle wheel. The auxiliary wheel is having a diameter that is relatively smaller than a diameter of a tyre of the vehicle wheel. The auxiliary wheel is having a diameter that is relatively larger than a diameter of a rim of the vehicle wheel. The auxiliary wheel facilitates the vehicle to be driven at a reduced speed without limitation in the under inflated or deflated state of vehicle wheel.

In an embodiment the user configured means is a plurality of holes equidistantly disposed along the first side of the auxiliary wheel such that the holes are covered by the tyre thereby highlighting contrast in colour between the vehicle wheel and the auxiliary wheel during under inflated of deflated state of the vehicle wheel.

In an alternative embodiment, the user configured means is a plurality of light emitting diodes is connected to a plurality of pieso cell generators through a printed circuit board. The light emitting diodes are positioned on the first side of the auxiliary wheel. The pieso cell generators and the printed circuit board are positioned on the second side of the auxiliary wheel. The printed circuit board undergoes a press and release cycle due to rotation of the auxiliary wheel during the under inflated or deflated state of the vehicle wheel. The press and release cycle causes the pieso cell generators to light up the light emitting diodes to give remote indication of the under inflated or deflated state of the vehicle wheel.

In another alternative embodiment, the user configured means is a plurality of prongs that is mounted on a side wall at a progressively away oriented distance from the auxiliary wheel. Each of the prongs includes a pieso sensor that is connected to a predefined coloured set of light emitting diodes. Each of the prongs contacts with the vehicle wheel in a substantially different under inflated or deflated state to light up a substantially different predefined coloured set of the light emitting diodes.

### BRIEF DESCRIPTION OF DRAWINGS

FIG. 1 is a front perspective view of an auxiliary wheel apparatus constructed in accordance with a preferred embodiment of the present invention;

FIG. 2 shows a preferred method of coupling the auxiliary wheel of FIG. 1 to a vehicle wheel along a central axis-X of an axle of the vehicle wheel;

FIG. 3 is a perspective view that shows positioning of the auxiliary wheel of FIG. 1 on the vehicle wheel;

FIG. 4 is a perspective view of a first embodiment of the auxiliary wheel of FIG. 1 that shows a plurality of fins coupled on a first side of the auxiliary wheel;

FIG. 5 is a front perspective view of a second embodiment of the auxiliary wheel of FIG. 1 that includes a plurality of through holes along the first side of the auxiliary wheel;

FIG. 6a is a front view of a third embodiment of the auxiliary wheel of FIG. 1 that shows a plurality of LEDs mounted on the first side of the auxiliary wheel;

FIG. 6b is a back view of the auxiliary wheel of FIG. 6a that shows a circular printed circuit board (PCB) being mounted on the second side of the auxiliary wheel;

FIG. 7a is a top perspective view of a fourth embodiment of the auxiliary wheel of FIG. 1 that shows a plurality of piezoelectric sensor arms disposed along a first side of the auxiliary wheel;

FIG. 7b is a side view of the auxiliary wheel of FIG. 7a in a normal condition; and

FIG. 7c is a side view of the auxiliary wheel of FIG. 7b in a deflated condition.

### DETAILED DESCRIPTION OF THE DRAWINGS

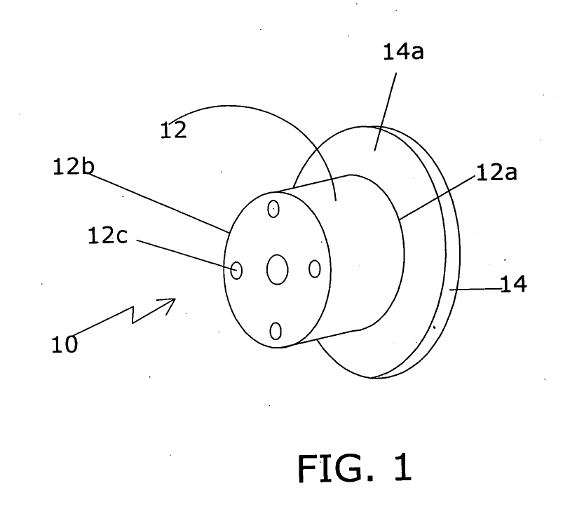

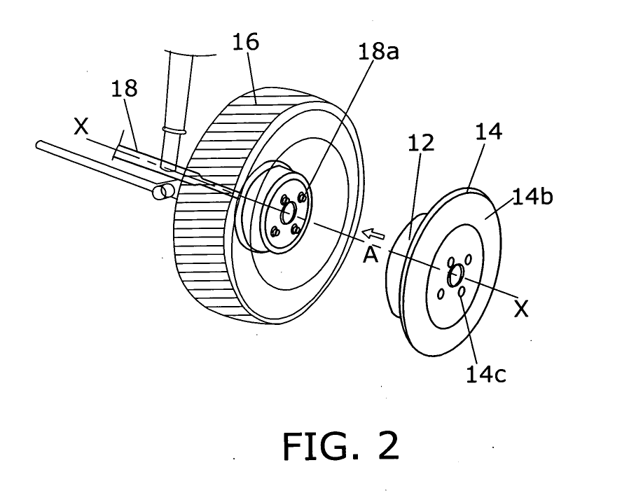

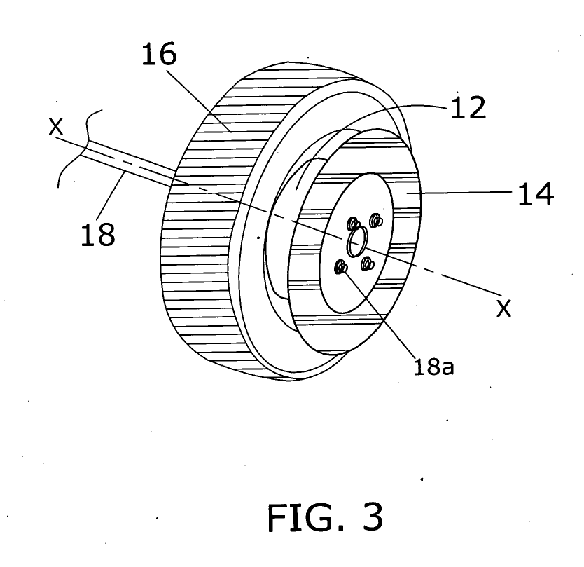

Referring to FIGS. 1-3, an auxiliary wheel apparatus 10 in accordance with a preferred embodiment of the present invention is described. The auxiliary wheel apparatus 10 includes a cylindrical projection 12, and an auxiliary wheel 14. The cylindrical projection 12 is permanently coupled to the auxiliary wheel 14. The cylindrical projection 12 preferably horizontally extends along an axis that passes through a centre of the auxiliary wheel 14. The cylindrical projection 12 has a first end 12a and a second end 12b. The first end 12a is preferably permanently connected to a rear end 14a the auxiliary wheel 14 in this one embodiment. The second end 12b is configured to be removably coupled to a vehicle wheel 16. The second end 12b includes a plurality of holes 12c. The axle 18 includes a plurality of screws 18a. The screws 18a are adapted to be positioned in the holes 12c to connect the auxiliary wheel 14 to the vehicle wheel 16.

The auxiliary wheel 14 is coupled to the vehicle wheel 16 by moving the auxiliary wheel 14 in a direction as indicated by an arrow ‘A’ in this one particular embodiment. However, it is understood here that the auxiliary wheel 14 may be connected to the vehicle wheel 16 by other alternative connecting means. The auxiliary wheel 14 in accordance with the present invention is coupled to the vehicle wheel 16 along a central horizontal axis-X of the axle 18. The auxiliary wheel 14 is preferably aligned along a plane that is substantially parallel to a plane of rim 16a. It is understood, however, that the sides of the auxiliary wheel 14 do not interfere with the vehicle wheel 16 in a stationary or moving position of the vehicle. The auxiliary wheel 14 has a front end 14b that includes a plurality of holes 14c. The holes 14c are located in a circular fashion on the front end 14b. The holes 14c facilitating connection of a plurality of user configured means thereto. The user configured means are adapted to provide an early indication of the deflated state of the vehicle wheel to a remote observer.

In operation, the auxiliary wheel 14 preferably rotates at a predefined speed of the vehicle wheel 16 due to connection between the auxiliary wheel 14 and the vehicle wheel 16. The auxiliary wheel 14 is configured to establish contact with ground in case where tyre undergoes deflation due to puncture or any such other reason. In such case, the auxiliary wheel 14 advantageously protects sides of the tyres of the vehicle wheel 16 on which the auxiliary wheel 14 is mounted. In case of sudden deflation of the vehicle wheel 16 while moving at high speed, the auxiliary wheel 14 supports the vehicle enabling the vehicle to maintain control. In such cases, the vehicle experiences change in driving characteristics due to failure of non pneumatic auxiliary wheel 14. However, the auxiliary wheel 14 facilitates the vehicle to be driven with a reduced speed without limitation. The auxiliary wheel 14 prevents the rim 16a to come in contact with the ground during the deflated state of the tyre in a moving condition of the vehicle. In addition, the auxiliary wheel 14 protects the respective vehicle wheel 16 from sharp objects and hazards during the movement of the vehicle.

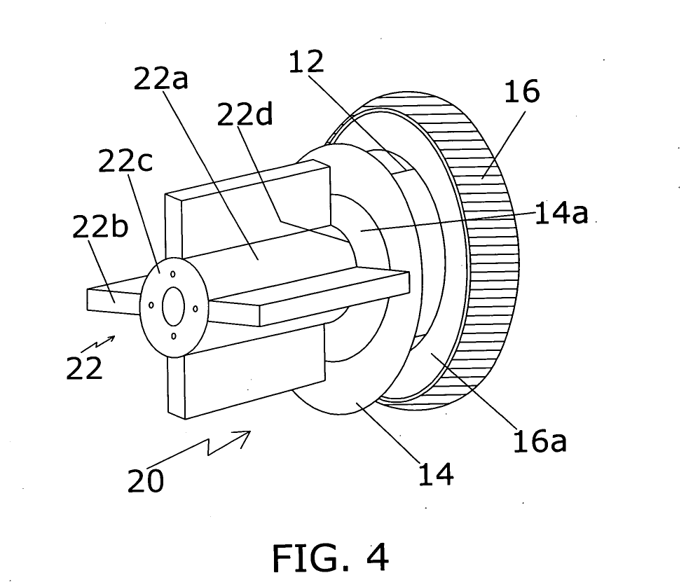

Referring to FIG. 4, an alternative embodiment of an auxiliary wheel apparatus 20 is described. The auxiliary wheel apparatus 20 includes a cylindrical projection 12, and an auxiliary wheel 14. The cylindrical projection 12 preferably outwardly extends from a vehicle wheel 16. In this one alternative embodiment, the auxiliary wheel 14 includes a first side 14a that includes a finned structure 22 that is normally positioned thereon. The finned structure 22 includes a fin shaft 22a, a plurality of fins or blades 22b, a first end 22c and a second end 22d. The blades 22b are integrally connected to the fin shaft 22a in this one embodiment. In this one embodiment, the auxiliary wheel 14 includes four fins 22b. However it is understood that the number of fins 22b may vary per intended application of the auxiliary wheel 14.

In operation, the fins 22b enable facilitate a traction boost to the vehicle wheel if the vehicle is driven on soft ground, such as a soggy muddy terrain or a ground covered with snow, for example. The fins 22b operate only when the main wheels 16 sink thereby causing the fins 22b to come into contact with the terrain. It is understood here that a radial length and an axial length of the fins 22 is preferably optimized to complement the type of tyre threads and the terrain to which the vehicle is intended to be driven.

It is also understood that the fins 22b may be foldably positioned within fin shaft 22a in other alternative embodiments of the present invention. In this one alternative embodiment, the fins 22b are preferably hinged on the first end 22c and the second end 22d. The foldable fins 22b respectively define a first closed position, and a second open position. The first closed position is such that the foldable fins remain at a predefined position inside the fin shaft 22a. In the first position, the fins 22b enable normal operations of the vehicle. The second position is such that the foldable fins 22b normally extend at a predefined height from the fin shaft 22a. In the second position, the foldable fins 22b advantageously magnify the thrust while negotiating soft terrain fields.

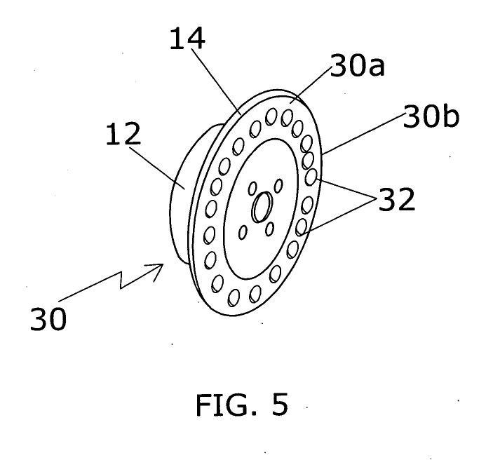

Referring to FIG. 5, a second alternative embodiment of an auxiliary wheel apparatus 30 is described. The auxiliary wheel apparatus 30 includes a cylindrical projection 12, and an auxiliary wheel 14. The auxiliary wheel 14 includes a plurality of through holes 32 that are preferably equidistantly positioned along a first side 30a of the vehicle wheel 16. The holes 32 preferably dispose in the proximity to an outer periphery 30b of the vehicle wheel 16. It is understood here that the auxiliary wheel apparatus 30 is preferably positioned at a predefined distance from the vehicle wheel 16 such that during the instance of under inflation or deflation of the vehicle wheel 16 below a recommended threshold, the side wall of the tyres of the vehicle wheel 16 experiences lateral inflation and contacts with the auxiliary wheel 14 preferably in the region where the tire contacts with the ground.

In operation, depending on the inflated state of the tyre in combination with the weight in the vehicle, the vehicle wheel 16 preferably covers respective number of holes 32 on the auxiliary wheel 14. In such instance, a visual indication of an inflated state is presented which is highlighted due to contrast in colour between the vehicle wheel 16 and the auxiliary wheel 14. This provides a strong visual indication to a remote observer about inflated state of the vehicle wheel 16 thereby acting a warning system that avoids potential danger that may arise due to inflated state of the vehicle wheel.

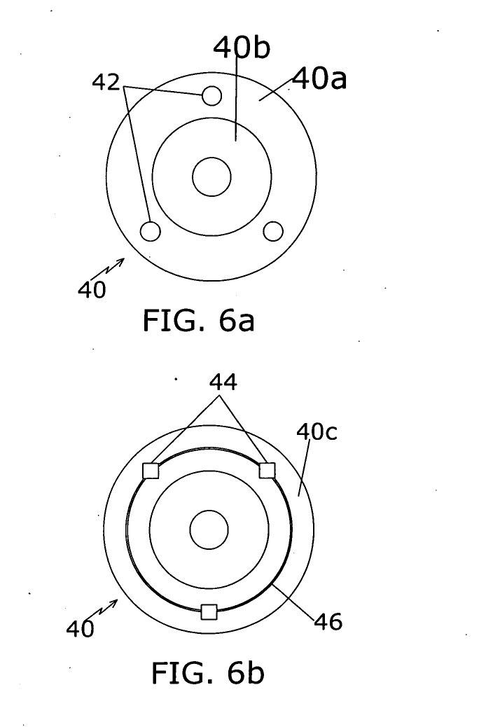

Referring to FIGS. 6a and 6b, a third alternative embodiment of an auxiliary wheel apparatus 40 is described that includes a plurality of Light Emitting Diodes (LEDs) 42, a plurality of pieso cell generators 44, and a Printed Circuit Board (PCB) 46. In this one alternative embodiment, LEDs 42 are preferably positioned in a circular pattern on a first side 40a of the auxiliary wheel 14. In this one embodiment, the LEDs 42 are shown to be positioned around a center portion 40b of the auxiliary wheel 14. However, it is understood here that the orientation of the LEDs 42 may change in other alternative embodiments of the auxiliary apparatus 40. The PCB 46 has a metallic conductor derived path (not shown) through which the piezo cell generators 44 are connected to the PCB 46. In this embodiment, the PCB 46 is preferably made of plastic material and is of circular shape. However, it is understood that material of construction and shape of the PCB 46 may change in other alternative embodiments per intended application of the auxiliary wheel apparatus 40. In this one embodiment, the PCB 46 is preferably screwed on a second side 40c of the auxiliary wheel 14. It is understood, however, that the components 42 and 44 of auxiliary wheel 14 are positioned in a predefined arrangement in accordance with the vehicle wheel 16 thereby qualifying balancing requirements of the vehicle wheel 16.

In operation, the auxiliary wheel apparatus 40 is adapted to be rotated with a vehicle wheel 16 such that the vehicle wheel 16 under deflated state of air below a preset threshold undergoes inflation thereby contacting with the PCB 46. It is understood here that the auxiliary wheel 14 is in contact with the ground during such instance. In such situation, the PCB 46 undergoes through a press and release cycle due to rotation of the vehicle wheel 16 that causes the pieso cell generators 44 to light up the LED 42. The lighted LEDs 42 advantageously give remote indication of inflated state of the vehicle wheel 16. The PCB 46 may include an energy storage component, for example, a capacitor that enables the LED 42 to continue being lit for a predefined time when vehicle stops and achieves a steady state. The LEDs 42 are configured to return to a non luminous state when vehicle wheel 16 moves from the steady state to a running state. It is understood here that the energy consumption by a vehicle is significantly dependent on the state of inflation of a tire. Also, it is understood here that the auxiliary wheel apparatus 40 may use at least one video camera to identify and automatically post notice to the vehicle driver about inflated state of the vehicle wheel 16.

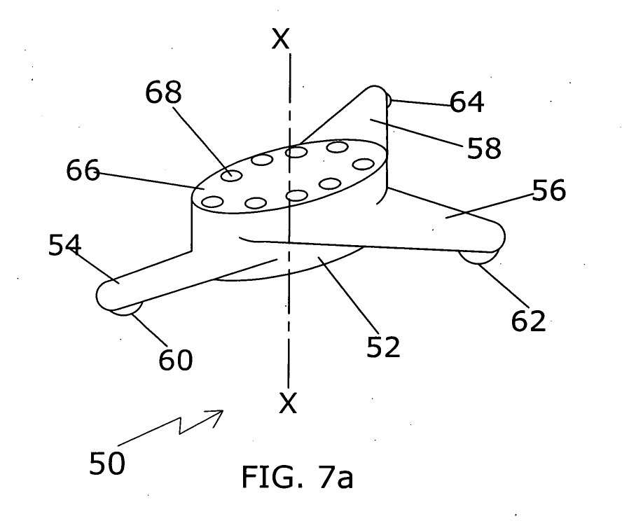

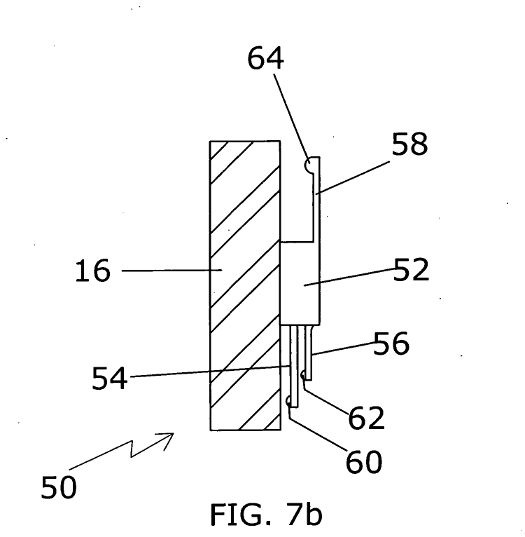

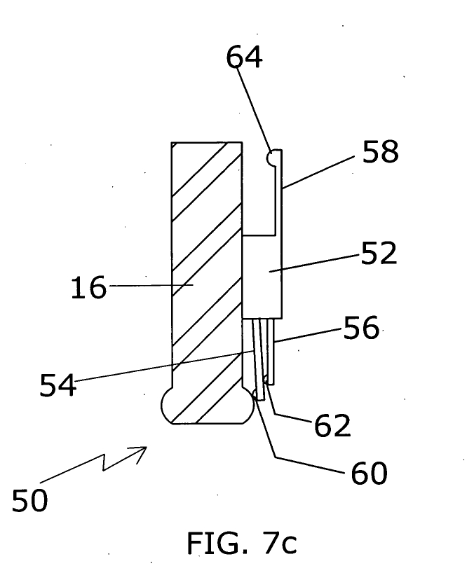

Referring to FIGS. 7a, 7b and 7c, a fifth alternative embodiment of an auxiliary wheel apparatus 50 is described that includes a plurality of prongs mounted along a sidewall 52 of the auxiliary wheel 50. In this one alternative embodiment, the auxiliary wheel 50 includes three prongs namely a first prong 54, a second prong 56 and a third prong 58. However, it is understood here that the number of prongs would change per size of the vehicle wheel 16. Each of the prongs 54, 56, 58 preferably normally extends with respect to a central vertical axis X-X in this one alternative embodiment. However it is understood here that each of the prongs 54, 56, 58 is disposed along a plane that is parallel to a plane defined by the vehicle wheel 16. The prongs 54, 56, 58 are positioned on the wheel 50 such that each of the prongs 54, 56, 58 in a progressively away oriented pattern from the plane of the wheel 16. The first prong 54 is positioned at a first distance from the vehicle wheel 16. The second prong 56 is positioned at a second distance from the vehicle wheel 16. The third prong 58 is positioned at a third distance from the vehicle wheel 16. The first distance is relatively lesser the second distance and the second distance is relatively lesser than the third distance in this one particular embodiment. The prongs 54, 56, 58 are configured to prevent contact with the wheel 52 in normal ambient working conditions of the vehicle wheel 16 wherein the tires are having rated pressurised air therein. Each of the prongs 54, 56, 58 has a distal end that includes a pieso sensor. In this one embodiment, first prong 54, second prong 56 and third prong 58 respectively include a first pieso sensor 60, a second pieso sensor 62 and a third pieso sensor 64. The pieso sensors 60, 62 and 64 are respectively connected to a set of LEDs having a different colour from each other. In this one particular embodiment, the first pieso sensor 60 is connected to a set of green coloured LED. The second pieso sensor 62 is connected to a set of yellow coloured LEDs. The third pieso sensor 64 is connected to a set of red coloured LEDs. The auxiliary wheel 50 has a rear surface 66 that includes a plurality of holes 68 adapted to facilitate engagement with a plurality of screws defined on an axle of the vehicle wheel 16. The holes 68 are preferably configured in a circular fashion over the rear surface 66 in this one embodiment. Each of the prongs 54, 56, 58 is preferably made of flexible material, such as plastic or plastic based composites, in this one embodiment that advantageously prevents permanent deformation of the prongs 54, 56, 58 during operation

In operation, under a small inflated or overloaded state of the vehicle, the first prong 54 comes into contact with the tire of vehicle wheel 16 such that the first pieso sensor 60 generates power to light up the first set of green coloured LEDs. In operation, under a more pronounced under inflation state of the vehicle wheel 16, the second prong 56 which is closer to the plane of the wheel comes into contact with the tire of the vehicle wheel 16 such that the second pieso sensor 62 generates power to light up the second set of yellow coloured LEDs. In operation, under a further pronounced under inflated or deflated state of the vehicle wheel 16, the third prong 58 which is closer to the plane of the wheel comes into contact with the tire of the vehicle wheel 16 such that the third pieso sensor 64 generates power to light up the third set of red coloured LEDs. It is understood here that the auxiliary wheel 50 includes a controlling circuit (not shown) that is embedded in the auxiliary wheel along with a battery or capacitor (not shown). The prongs 54, 56 and 58 charge the battery to facilitate an energy source of the light in a stopped condition of the vehicle.

### ADVANTAGES OF THE PRESENT INVENTION

1. The use of auxiliary wheel apparatus 10 substantially reduces energy consumption of the vehicle as it provides an early indication means of the state of inflation of a tire which largely saves energy consumption of the vehicle by substantially reducing increased forward drag and lateral steering effects being imparted on the vehicle.

2. The auxiliary wheel apparatus 14 allows governance over fuel wastage due to inflated state of tyres that may arise due to increased forward drag and steering effects under inflated or deflated stage of the vehicle wheel.

3. The auxiliary wheel apparatus 14 advantageously imparts economy of fuel and driving safety enhancement that has enormous implication in reducing the carbon foot print.

4. The auxiliary wheel apparatus 10 may include use of at least one video camera to identify and automatically post notice to the vehicle driver about inflated state of the vehicle wheel 16.

5. The fins 22b of the auxiliary wheel apparatus facilitate a traction boost to the vehicle wheel if the vehicle is driven on soft ground, such as a soggy muddy terrain or a ground covered with snow

6. The fins 22b are foldable to define a first closed position and a second open position wherein the fins 22b remain at a predefined position inside the fin shaft 22a during normal operation and extend at a predefined height to advantageously magnify the thrust while negotiating soft terrain fields.

7. The prongs 54, 56 and 58 charge the battery to facilitate an energy source of the light in a stopped condition of the vehicle.

8. The LEDs on the prongs 54, 56 and 58 give three different colour indications about three different deflation stages of the vehicle wheel 16 to a remote observer.

I claim:

1. An auxiliary wheel apparatus for a vehicle, the auxiliary wheel apparatus comprising:
an auxiliary wheel having a front end and a rear end, the front end having a plurality of holes facilitating connection of a plurality of user configured means thereto, the user configured means giving an early indication of an under inflated or deflated state of the vehicle wheel to a remote observer; and
a cylindrical projection having a first end and a second end, the first end permanently connecting to the rear end of the auxiliary wheel, the second end having a plurality of holes connecting to a plurality of screws defined on an axle of the vehicle wheel for facilitating engagement between the auxiliary wheel and the vehicle wheel, the cylindrical projection keeping the auxiliary wheel at a predefined distance from the vehicle wheel, the auxiliary wheel contacting and rotating on a ground by facilitating support in the under inflated or deflated state of the vehicle wheel.

2. The auxiliary wheel apparatus as claimed in claim 1, wherein the auxiliary wheel is having a diameter that is relatively smaller than a diameter of a tyre of the vehicle wheel.

3. The auxiliary wheel apparatus as claimed in claim 1, wherein the auxiliary wheel is having a diameter that is relatively larger than a diameter of a rim of the vehicle wheel.

4. The auxiliary wheel apparatus as claimed in claim 1, wherein the auxiliary wheel facilitates the vehicle to be driven at a reduced speed without limitation in the under inflated or deflated state of vehicle wheel.

5. The auxiliary wheel apparatus as claimed in claim 1, wherein the user configured means is a plurality of holes equidistantly disposed along the first side of the auxiliary wheel.

6. The auxiliary wheel apparatus as claimed in claim 5, wherein the holes are covered by the tyre thereby highlighting contrast in colour between the vehicle wheel and the auxiliary wheel during under inflated of deflated state of the vehicle wheel.

7. The auxiliary wheel apparatus as claimed in claim 1, wherein the user configured means is a plurality of light emitting diodes are connected to a plurality of pieso cell generators through a printed circuit board.

8. The auxiliary wheel apparatus as claimed in claim 7, wherein the light emitting diodes are positioned on the first side of the auxiliary wheel.

9. The auxiliary wheel apparatus as claimed in claim 8, wherein the pieso cell generators and the printed circuit board are positioned on the second side of the auxiliary wheel.

10. The auxiliary wheel apparatus as claimed in claim 7, wherein the printed circuit board undergoes a press and release cycle due to rotation of the auxiliary wheel during the under inflated or deflated state of the vehicle wheel.

11. The auxiliary wheel apparatus as claimed in claim 10, wherein the press and release cycle causes the pieso cell generators to light up the light emitting diodes to give remote indication of the under inflated or deflated state of the vehicle wheel.

12. The auxiliary wheel apparatus as claimed in claim 1, wherein the user configured means is a plurality of prongs that is mounted on a side wall at a progressively away oriented distance from the auxiliary wheel.

13. The auxiliary wheel apparatus as claimed in claim 12, wherein each of the prongs includes a pieso sensor that is connected to a predefined coloured set of light emitting diodes.

14. The auxiliary wheel apparatus as claimed in claim 12, wherein each of the prongs contacts with the vehicle wheel under inflated or deflated state to light up a substantially different predefined coloured set of the light emitting diodes.

15. The auxiliary wheel apparatus as claimed in claim 12, wherein the prongs are configured to light up the light emitting diodes for a predefined amount of time.

16. The auxiliary wheel apparatus as claimed in claim 12, wherein the prongs are made of flexible material.

17. The auxiliary wheel apparatus as claimed in claim 15, wherein the prongs are adapted to prevent permanent deformation during the operation thereof.
